(19) United States
(12) Patent Application Publication
(10) Pub. No.: US 2008/0147861 A1
(43) Pub. Date: Jun. 19, 2008

(54) Data distribution network and an apparatus of index holding

(76) Inventors: Takumi Oishi, Kodaira (JP); Tatsuhiko Miyata, Kokubunji (JP); Masahiro Yoshizawa, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/707,087

(22) Filed: Feb. 16, 2007

(30) Foreign Application Priority Data
Dec. 13, 2006 (JP) 2006-335248

(51) Int. Cl. G06F 15/173

(52) U.S. Cl. 709/225

(57) ABSTRACT

A data distribution system is provided which, in a network where data is exchanged between users, prevents the users from downloading malicious data without knowing whether the data he or she is going to download is the desired data. In a system configuration, a network administrator makes publicly known to the users, distributor identifiers uniquely assigned to data distributors in advance, and prohibits a data distribution by a user with a distributor identifier when the administration is notified that a malicious data has been distributed from the user, thereby securing reliability of the data distributors. A signature of the data is used to detect tampered data and prevent such data from being redistributed. Further, a user who tampered with the data is identified and then prevented from using the network.

### INCORPORATION BY REFERENCE

The present application claims priority from Japanese application JP 2006-335248 filed on Dec. 13, 2006, the content of which is hereby incorporated by reference into this application.

### BACKGROUND OF THE INVENTION

The present invention relates to a communication method for transferring data among users and more particularly to a method for managing an initial data register and subsequent data transfers and an apparatus to implement it.

Napster published in 1999 in the United States triggered a rapid spread of peer-to-peer (hereinafter referred to as P2P) software that allows a large number of users to transfer data among them. It can be pointed out as a main factor for the widespread use that the P2P user can directly acquire data held by other users. Here, it is important that one can search to find who has the data he or she wants. That is, any data, even if it exists, cannot be acquired as long as its location is not found. This is equivalent to the target data not being existent.

Napster has a drawback that since a central server searches location information on all data, search operations concentrate in the server so that the search load on the server determines a performance of the system as a whole. Another drawback is that if the central server should fail, the system shuts down. The P2P system in which the central server resides is called a hybrid P2P.

To overcome these drawbacks, Gnutella (non-patent document 1; http://www9.limewire.com/developer/gnutella_protocol_{—}0.4.pdf) was made public in the United States in 2000. Gnutella eliminates the central server for search operations and sends search requests and responses back and forth among user PCs (in a bucket relay fashion). Although this has overcome the drawbacks of Napster, it has staggeringly increased the traffic volume of search. The bucket relay type search takes time and an actual search has a time limitation, giving rise to a new drawback that there may be an occasion where data, though it is existent, cannot be found by the search. This Gnutella does not require the central server for searching data location and thus is distinguished from the pure P2P.

In Japan P2P software has come to be widely known following the advent of Winny (non-patent document 2: Technology of Winny, ISBN4-7561-4548-5) published in 2002. Winny, categorized as the pure P2P, has a function of caching data being transferred in a node installed in a data transfer path although this function is not essentially necessary. This can be expected to improve a data transfer speed.

In 2001 BitTorrent (non-patent document 3: http://www.bittorrent.org/protocol.html) was made public in the United States. This hybrid P2P software, contrary to common knowledge about ordinary client-server systems, is characterized in that the more popular the data and the greater the number of people wishing to acquire that data, the higher the acquisition speed gets. This software employs a scheme which divides data into smaller pieces and allows users to acquire those pieces missing in their own data. So, the more popular the data is, the more prospective users there will be who can offer those pieces lacking in his or her data, resulting in an improved acquisition speed. Particularly, since the advantage of acquisition speed improvement increases as the size of data becomes large, like video data, this software has begun its commercial service as a means of distributing video data such as TV dramas.

Although it is a hybrid P2P, BitTorrent, unlike Napster, avoids the weak point of the central server by not having a data location search function. While this requires the user to search data by another method, it makes the load on the central server that much smaller. Further, by having a plurality of central servers, BitTorrent prevents the system as a whole from being shut down when a single central server stops. This will be explained briefly as follows.

In BitTorrent the central server is called a tracker and holds and manages attributes of various data. This tracker can be installed freely by any user who wants to distribute data. The data attribute includes information about which part of the entire data each piece represents, a data amount of each piece, a signature of each piece, a list of IP addresses of nodes holding these pieces, and the number of times that these pieces of information have been acquired. There are two or more trackers but the attribute of particular data is held in a single tracker.

To acquire data it is necessary to know which tracker has an attribute of the desired data. A file containing this information is called a Torrent file. From the Torrent file the user can know the IP address of the tracker which in turn offers an IP address of the nodes keeping the desired data. Therefore, the first thing the user must do is to search the Torrent file associated with the desired data.

Normally, the Torrent file is published on a web site and thus can be found by an ordinary search using a keyword. It is therefore very difficult to distribute data one wishes to make public only to a particular user group. It is also very difficult to conceal the existence of the data from other than a particular user group. To cope with this situation, JP-A-2006-236349 discloses a method which, when executing a data search using a distributed hash technique, checks a user identifier to verify if the user is authorized to search.

The procedure for acquiring data involves first searching a Torrent file by using a search engine service and then connecting to a tracker to obtain an IP address of the node holding the data. Then, the data is acquired from the node at the IP address taken from the tracker and its content is checked.

### SUMMARY OF THE INVENTION

Hereafter, tampered data and computer viruses are called malicious data and users who tamper data or distribute computer viruses are called malicious users.

BitTorrent and other P2P software have made it possible to exchange data freely among users and publish users' works on the Internet. On the other hand damaging data such as viruses have come to be acquired unknowingly and easily. For example, in BitTorrent the reliability of a Torrent file, i.e., whether what has been received is really the desired data, cannot be known until the Torrent file is actually used to download and check the data. Thus, close check can find that the data obtained is a virus or useless tampered data. Each tracker can record an IP address of a sending node for each data and an IP address of a downloading node, but cannot record a name of a user who has first distributed the data nor a name of a user name who downloaded the data.

Therefore, when considering the software application to commercial services such as sales of video data, the following problems arise from the viewpoint of safety and control of data distribution. Once data is distributed, the network administrator cannot take any control action later to prohibit the distributed data from being downloaded. Therefore, a data downloader can acquire malicious data unknowingly. Since the network administrator cannot identify the malicious user, the malicious user cannot be excluded from the network, giving rise to a risk of allowing a further distribution of malicious data.

It is not possible to check in advance the reliability of the data, i.e., whether the data a data downloader is going to obtain is what he wants. Thus, there occurs a danger of the data downloader's acquiring malicious data unknowingly. As a result the network administrator cannot provide data downloaders with security. Further, it is very difficult to distribute data only to particular user groups or conceal the presence of the data itself from other users than a particular user groups.

An object of this invention is to solve these problems and provide a network system that allows the network administrator to control data exchange among users so that data distributors and downloaders can use the system without anxiety.

To solve the above problems, a network administrator of a data distribution network in this invention assigns a unique distributor identifier to each data distributor in advance. The data distribution node includes means for registering an attribute of the data to be distributed with an index holding node by using a distributor identifier. A data download node includes means for searching the location of data by using a distributor identifier and a data name and acquire that data. The data download node also includes means responsive to a decision that the downloaded data is malicious data, for notifying the index holding node of an identifier of the downloaded data. The index holding node includes means for holding a data blacklist to manage identifiers of data obtained by notification. Further, the index holding node also includes means for making, to a search for the data listed on the data blacklist, a reply that the data does not exist.

In a network where users exchange data, by identifying both a distributing user and a downloading user of particular distributed data, the network administrator can take actions, such as prohibiting the transfer of that particular data and preventing the particular user from using the network. This excludes malicious data that may give damages to users and malicious users from the network, allowing the user to use the network safely.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates a network configuration of this invention.

FIG. 2 illustrates a data acquisition sequence.

FIG. 3 illustrates a data distribution sequence.

FIG. 4 illustrates a configuration of a data acquisition node.

FIG. 5 illustrates an example list of index holding nodes.

FIG. 6 is a flow chart showing an index lookup request procedure.

FIG. 7 is a flow chart showing a data acquisition function.

FIG. 8 is a flow chart showing black list processing.

FIG. 9 illustrates a configuration of a data distribution node.

FIG. 10 is a flow chart showing a data registration request procedure.

FIG. 11 is a data transfer flow chart.

FIG. 12 illustrates a configuration of an index holding node.

FIG. 13 illustrates an example of index.

FIG. 14 illustrates an example IP address table for index holding nodes.

FIGS. 15A-15C illustrate an example black list.

FIG. 16 illustrates an example IP address table of signature holding nodes.

FIG. 17 illustrates a signature table.

FIG. 18 illustrates a user statistic table.

FIG. 19 illustrates an example user information table.

FIG. 20 is a flow chart for a search response procedure.

FIG. 21 is a part 1 of a flow chart for an index search in an index holding network.

FIG. 22 is a part 2 of the flow chart for an index search in an index holding network.

FIG. 23 is a part 1 of a flow chart for a data transfer recording function.

FIG. 24 is a part 2 of the flow chart for a data transfer recording function.

FIG. 25 is a flow chart for data registration response procedure.

FIG. 26 is a part 1 of a flow chart for an index registration in an index holding network.

FIG. 27 is a part 2 of the flow chart for an index registration in an index holding network.

FIG. 28 illustrates a log-on sequence.

FIG. 29 is a flow chart for a logon to a data distribution network.

FIG. 30 is a flow chart for a logon acceptance function.

FIG. 31 illustrates an example index when data is divided into two pieces.

FIG. 32 illustrates a configuration of a user management node.

FIG. 33 illustrates a network configuration when a user management node is used.

FIG. 34 illustrates a logon sequence when a user management node is used.

FIG. 35 illustrates a data download sequence when a user management node is used.

FIG. 36 illustrates operations performed when a user tampers with data.

FIG. 37 illustrates operations performed when a data distributor distributes malicious data.

### DESCRIPTION OF THE EMBODIMENTS

Now, one embodiment of this invention will be described by referring to the accompanying drawings. First, a notion used in the following description will be explained. When an argument of a message is described in the explanation of an inter-node operation sequence and intra-node operation sequence in particular, elements of an argument are separated by comma in parentheses, like (vid, uid).

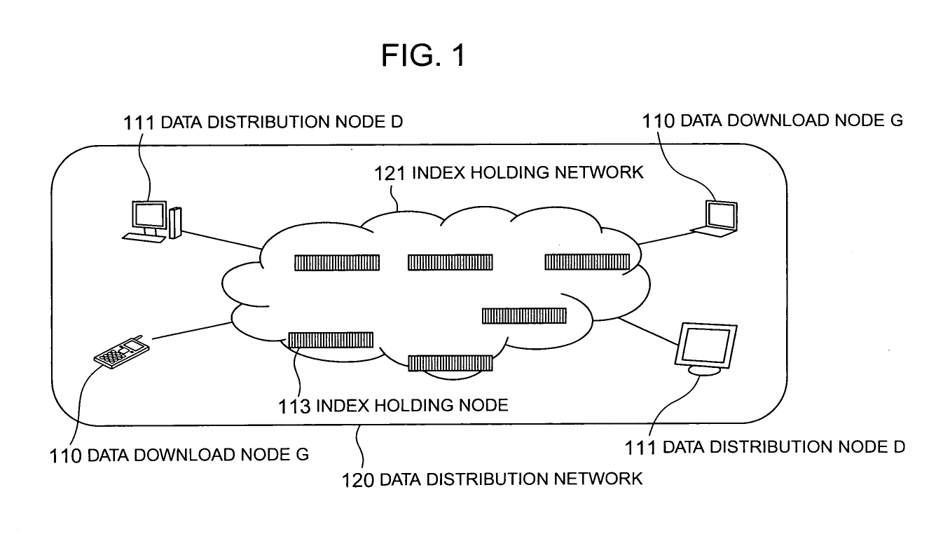

FIG. 1 illustrates an overall network configuration. A data distribution network 120 according to the embodiment of this invention comprises three components: a data download node 110, a data distribution node 111 and an index holding network 121. The index holding network 121 includes a plurality of index holding nodes 113. Note that user terminals such as PCs can be a data download node and a data distribution node at the same time. The data download nodes, the data distribution nodes and the index holding nodes are under the management of a network administrator. It is noted, however, that the nodes the network administrator has are only the index holding nodes, with the remaining nodes owned by users. This network 120 has mainly three functions of data distribution, data download and data attribute, and their associated functions. However, since the network does not have a search function to determine whether a data distributor exists or not, it is necessary, when downloading data, to use other means to obtain information about the existence of a distributor of the desired data. One of possible means may include publishing such information on a web site of the network administrator.

It is assumed that the data distributor applies to the network administrator in advance and is allocated a distributor identifier (hereinafter referred to as vid). It is also assumed that all users using this data distribution network are assigned a unique user identifier (called uid) beforehand by the network administrator. uid is required when using this data distribution network and is used in the logon operation. To prevent its malicious use by other users, as by spoofing, uid is kept secret from other users than an authorized user. vid is required when distributing data by using this data distribution network and is used in a data registration process. Therefore, vid can be made available to all users. uid has one-to-one correspondence with each user. As to vid, on the other hand, a single user can hold a plurality of vid's; one vid can be shared by a plurality of users; and a plurality of vid's can be shared by a plurality of users. Further, while vid can be assigned any preferred names by the user, such as company name, brand name and stage name, uid is specified by the data distribution network administrator.

When data is exchanged among users, it is usually difficult to know a source of the data, i.e., a first data distributor. vid has two meanings: one is to disclose a source of the data to the data downloader and the other is to explicitly show to the data distributor that the data is his or her work. The data downloader thus can use vid to decide the reliability of the data and the data distributor can be expected to become more careful with data distribution in order to make vid more reliable. This is because very few users will download data having the same vid as the one they fell victim to before.

The use of vid can also improve the level of ease with which data is downloaded. For example, all data having the same vid may be specified and downloaded at one time. At this time, there is no need to know a data name of each data. This means that vid can eliminate the labor and time of performing a search using the data name. For example, where series TV program data are distributed, the provision of dedicated vid obviates the need to download the data by specifying individual data names. Further, vid can improve the security of the network. For instance, when tampering is found in a plurality of data having a particular vid, an action may be taken to strengthen the monitoring on the users who download the data with this vid.

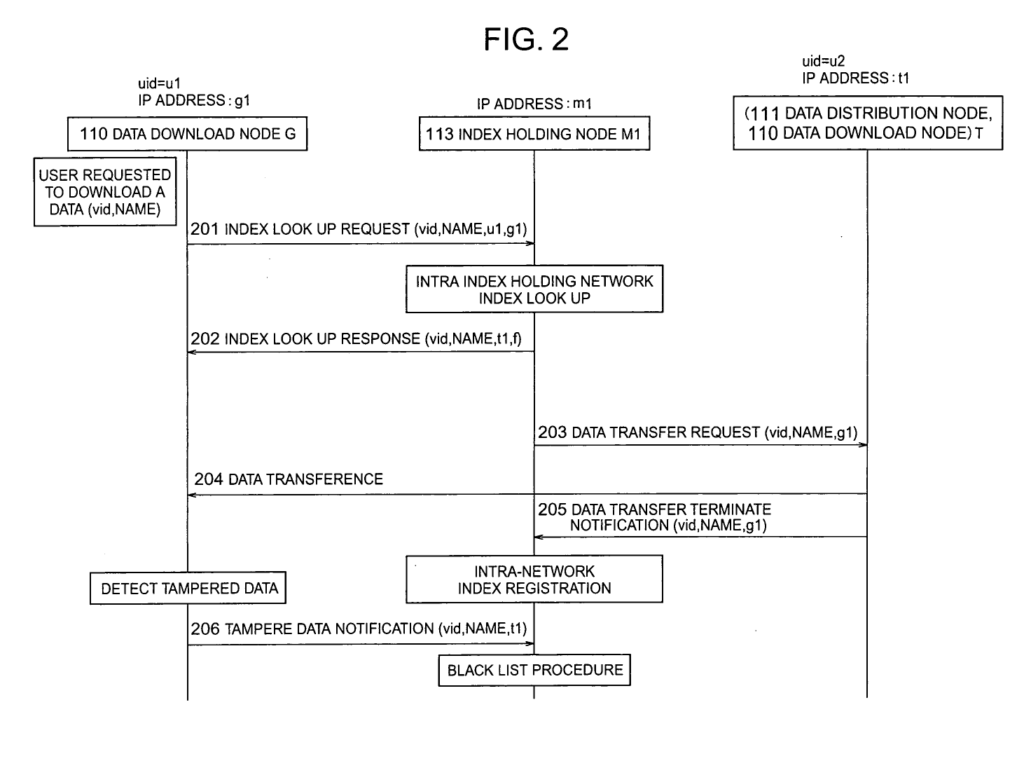

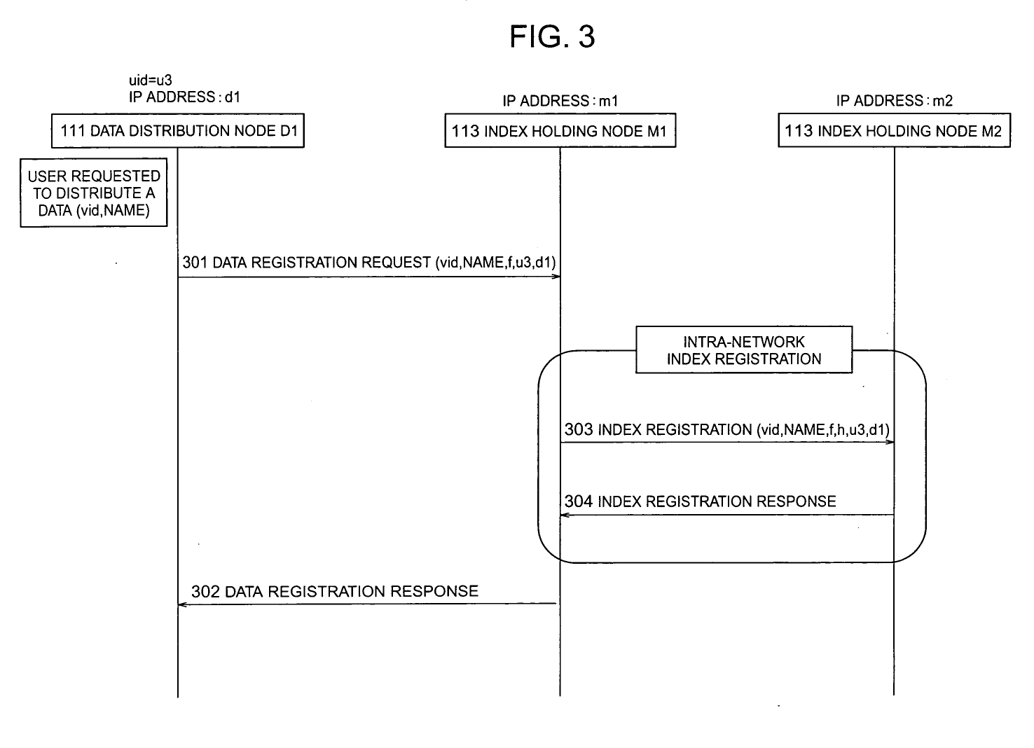

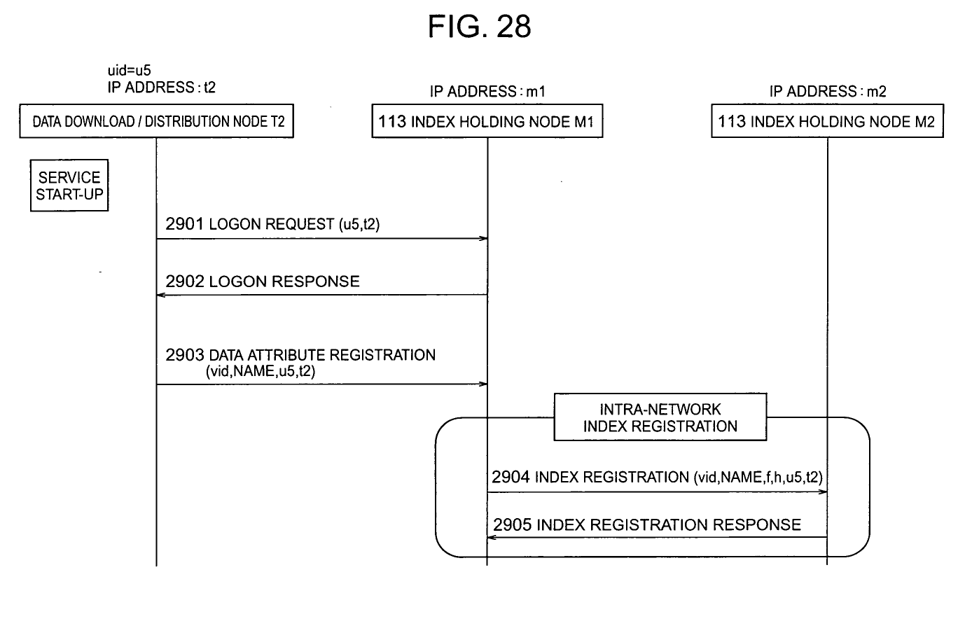

To use the data distribution network, the data distributor and the data downloader must first log on to the network. A logon sequence is shown in FIG. 28; a data downloading sequence is shown in FIG. 2; and a data distributing sequence is shown in FIG. 3. For ease of explanation, our explanation proceeds first to the data download sequence, followed by the data distribution sequence and then the logon sequence. The inter-node process sequence, the intra-node configuration and the intra-node process flow chart will be explained in that order.

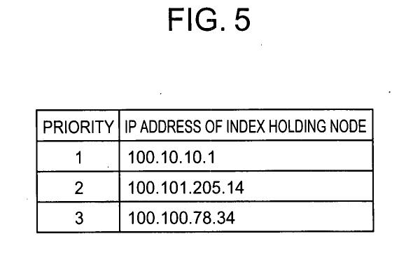

In FIG. 2 the data download node 110 (simply referred to as G) receives a data download request (vid, NAME) from the user. Here, NAME is a data name. First, in order to know an IP address of the node holding the data described above, G sends an index lookup request (vid, NAME, u1, g1) 201 to an index holding node 113 (simply referred to as M1). u1 is uid of G and g1 is an IP address of G. G needs to know the IP address of M1. Here, it is assumed, as shown in FIG. 5, that some settings are already made in G and that M1 is chosen at random.

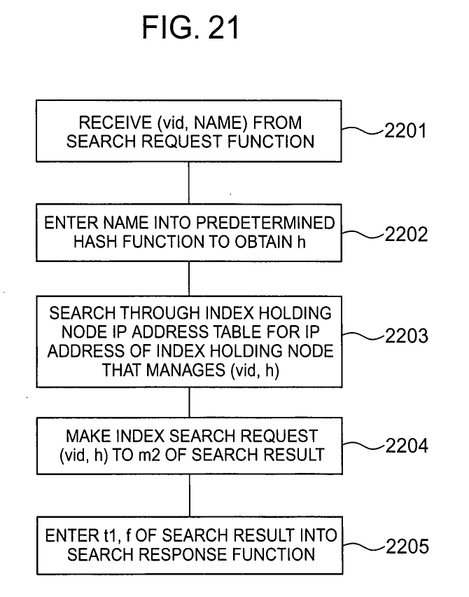

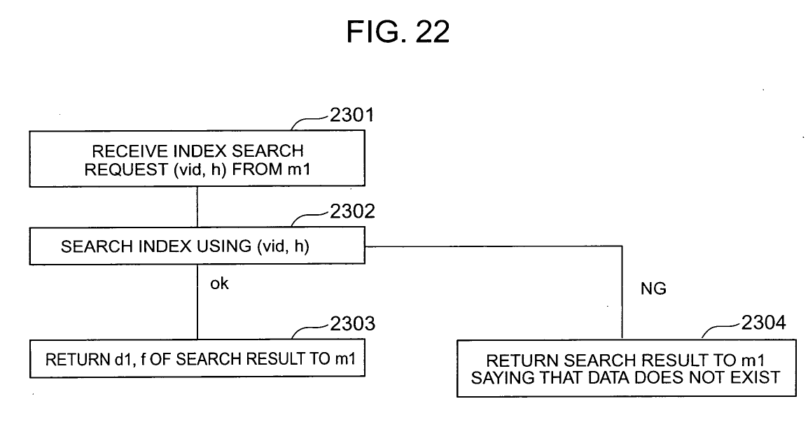

Upon receiving the index lookup request 201, M1 searches through the index holding network to acquire an IP address of a node holding the data (referred to as t1) and a signature f of the data. A node (referred to T) likely to hold the data specified by vid and NAME may be a data distribution node 111 (referred to as D1) or another different data download node (D2). Here, it is assumed that D2 has already obtained the data and is ready to redistribute it. Details of the search through the index holding network will be described by referring to the index holding node process flow charts of FIG. 21 and FIG. 22. M1 returns t1 and f in an index lookup response 202 to G.

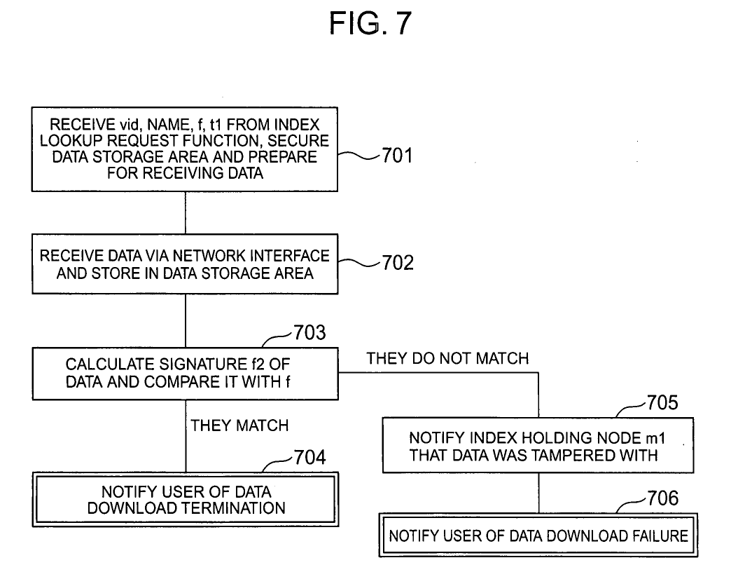

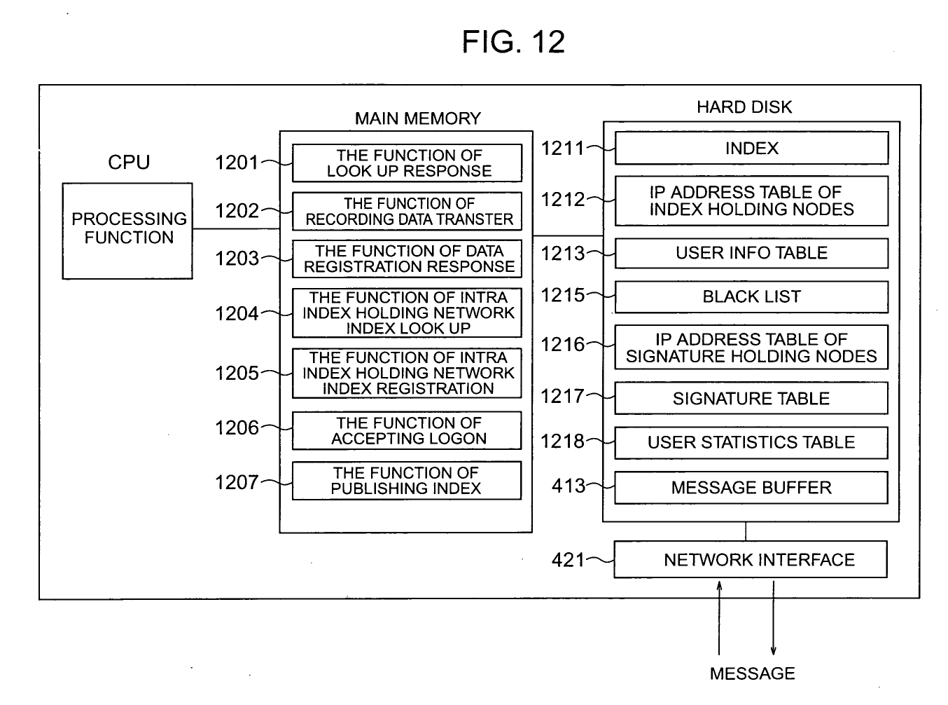

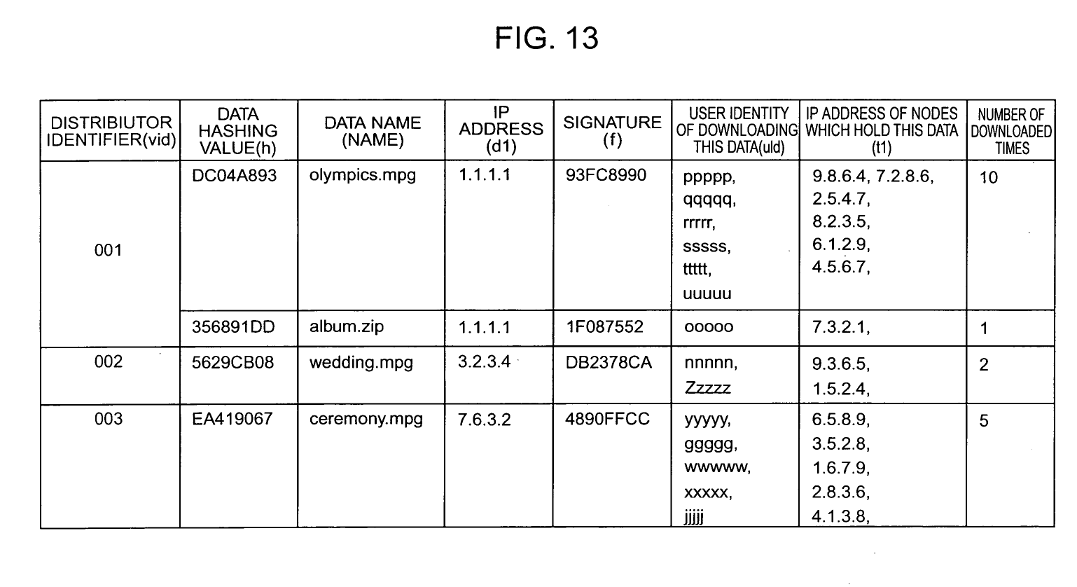

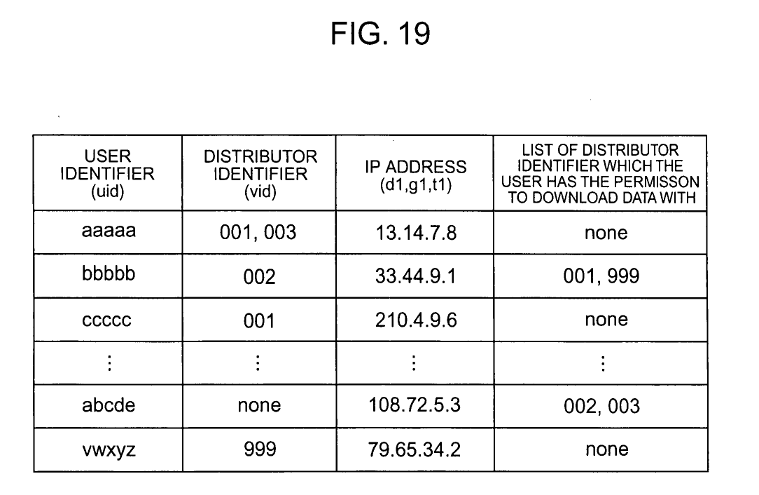

M1 sends a data transfer request (vid, NAME, g1) 203 to T (specified by t1) and T sends data specified by NAME to G (message 204). When the data transmission ends, T sends a data transfer terminate notification 205 to M1. This message causes the indices shown in FIG. 13 to be updated. G checks f to confirm that the downloaded data is not tampered with. This will be detailed by referring to FIG. 7. If the data tampering is detected, G sends a data tampering notification (vid, NAME, t1) 206 to M1. M1 picks up t1 from the received message, references a user info table (FIG. 19) described later, searches a user identifier u2 corresponding to t1, and then registers the u2 with the user blacklist 1503. The signature f is managed by the index holding node since it is important data used in detecting the tampering of the downloaded data. The blacklist will be described later with reference to FIG. 12.

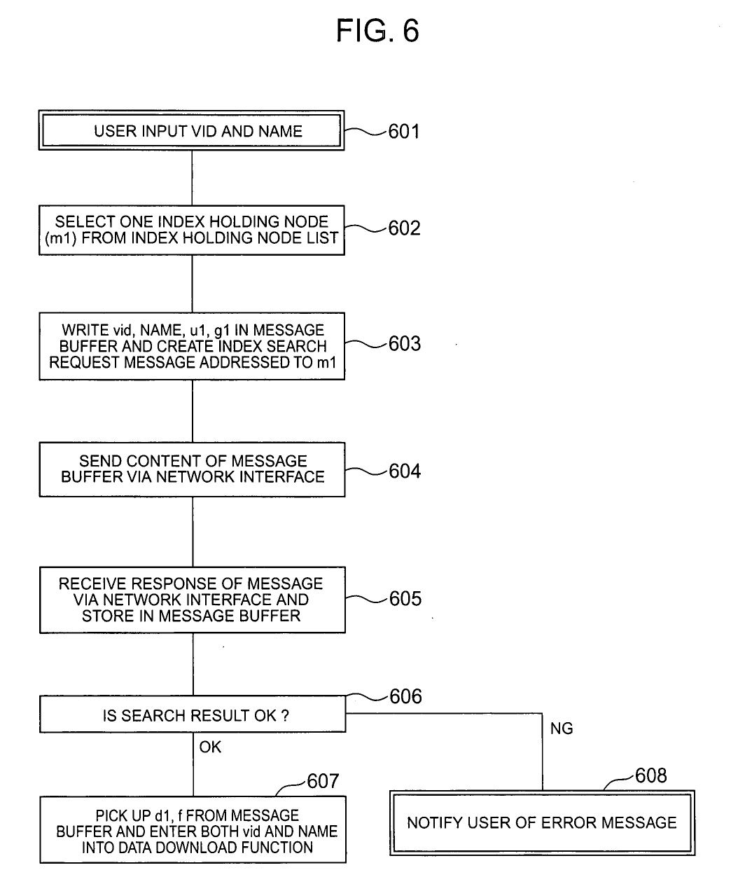

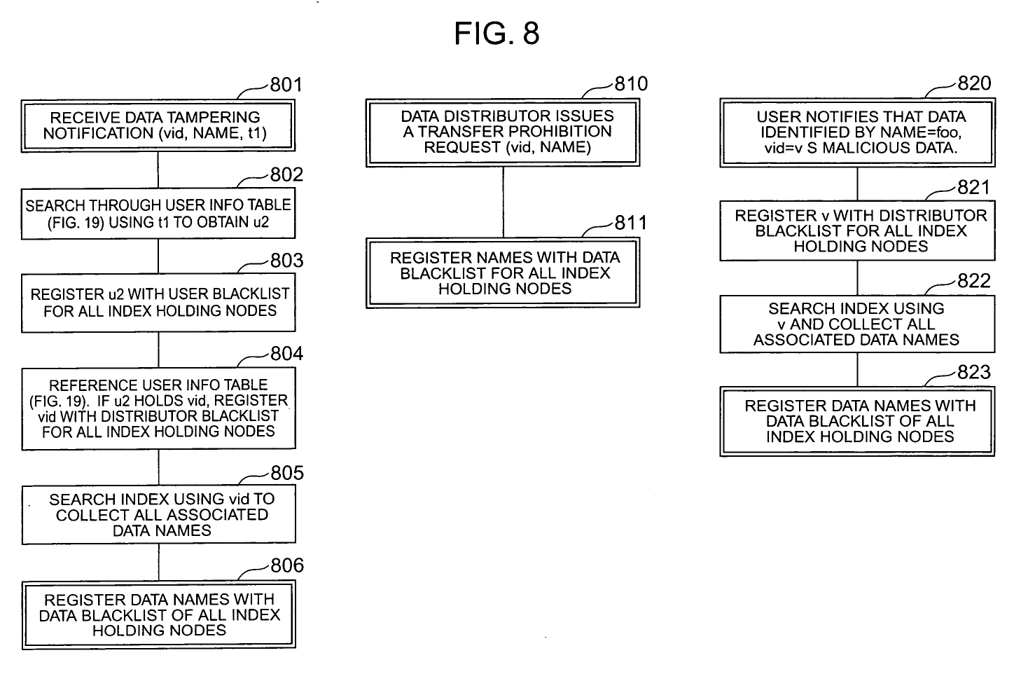

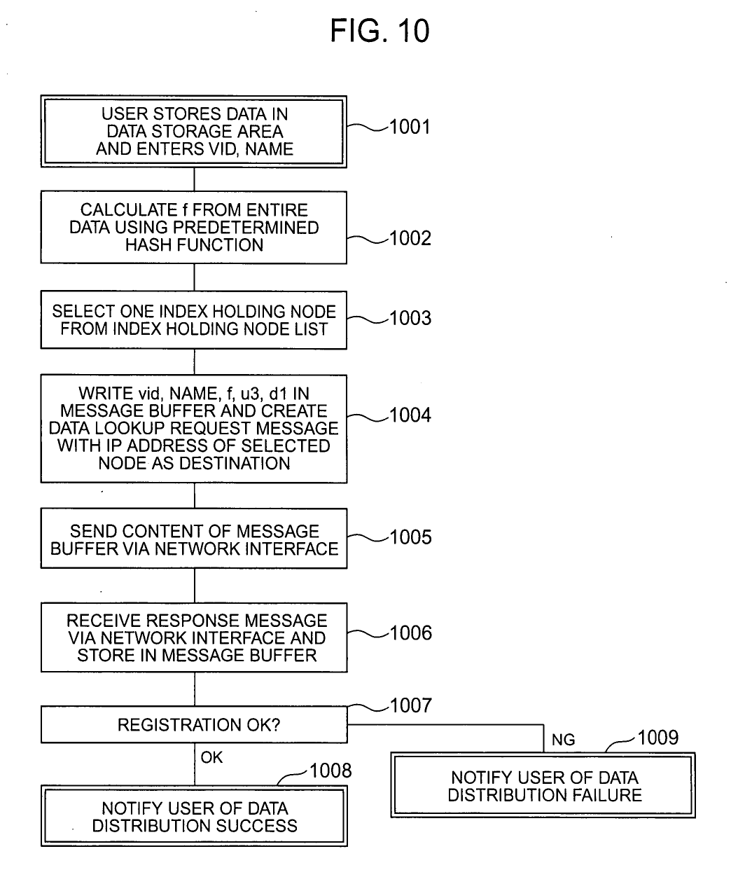

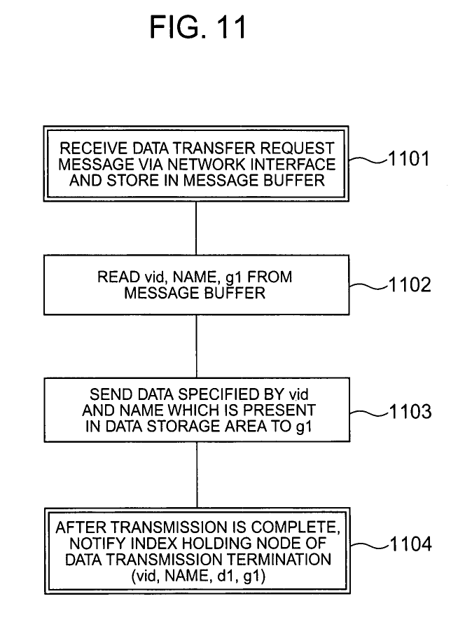

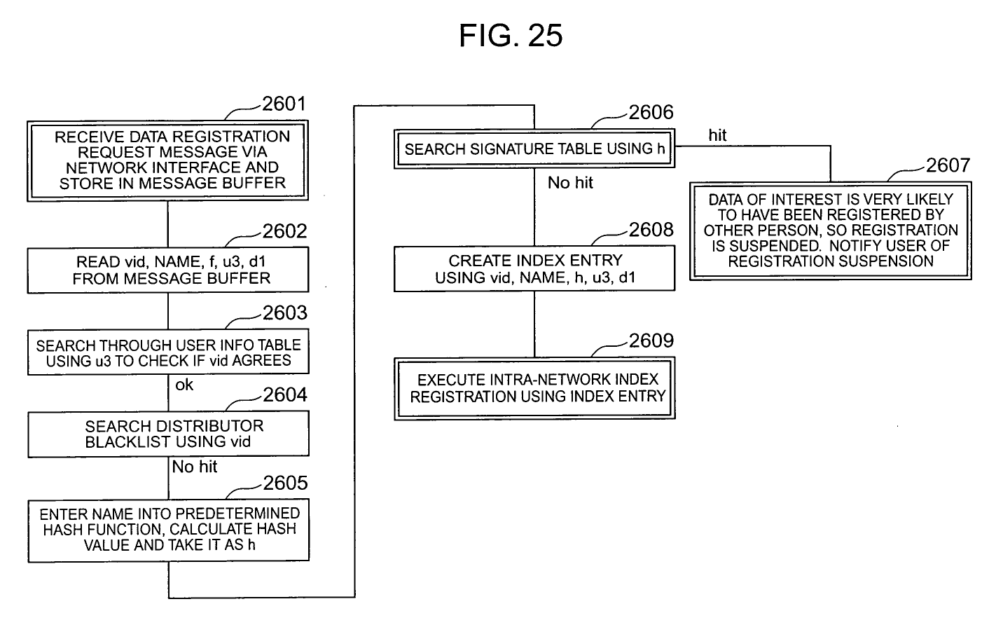

Details of these operations performed by G will be described in FIG. 6 and FIG. 7, the operations performed by T will be described in FIG. 11, and the operations on the part of M1 will be described in FIGS. 8, 20, 23 and 24. In FIG. 3 the data distribution node 111 (D1) receives a data distribution request (vid, NAME). D1 sends a data registration request (vid, NAME, u3, d1, f) to M1. Here, f represents a signature computed by D1, u3 represents a user identifier of a data distributor, and d1 represents an IP address of D1. Although D1 also needs to know the IP address of the index holding node, it is assumed here that some settings are made in D1 as shown in FIG. 5 and that an appropriate index holding node M1 is chosen. M1 processes the data registration request and notifies the result to D1. Details of the processes performed by D1 will be described in FIG. 10 and the process on the part of M1 will be explained by referring to the flow charts for the index holding node in FIGS. 25, 26 and 27.

FIG. 28 is a sequence for G and D1 to log on to the data distribution network. Since the sequence is the same for both G and D1, they are generally called T2. An IP address of T2 is taken to be t2 and its user identifier u5. After being started, T2 sends a logon request (u5, t2) 2901 to M1. When the logon is permitted by a logon response 2902, T2 performs a holding data information registration (vid, NAME, u5, t2) 2903 with M1 for all data that exists in a data storage area 412 or 912. M1 uses the received holding data information to perform an intra-network index registration (2904 and 2905). As a result, indices shown in FIG. 13 are updated.

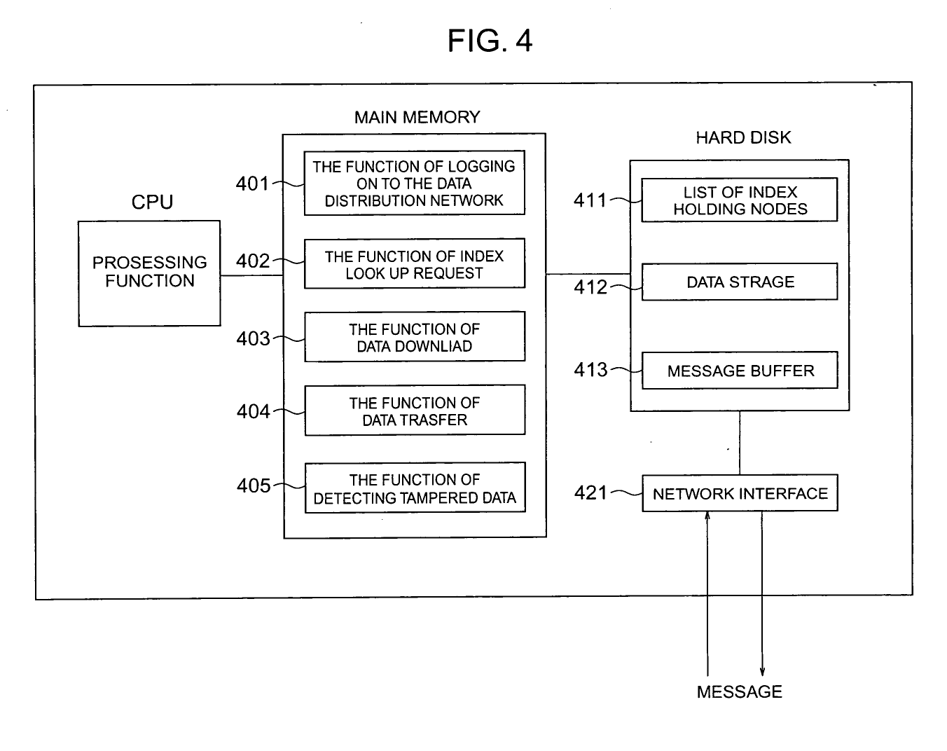

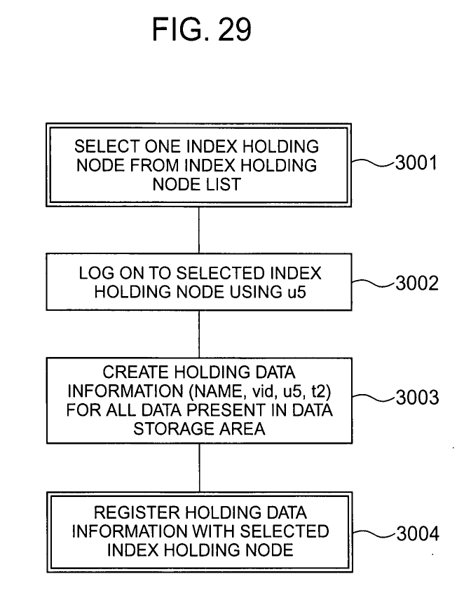

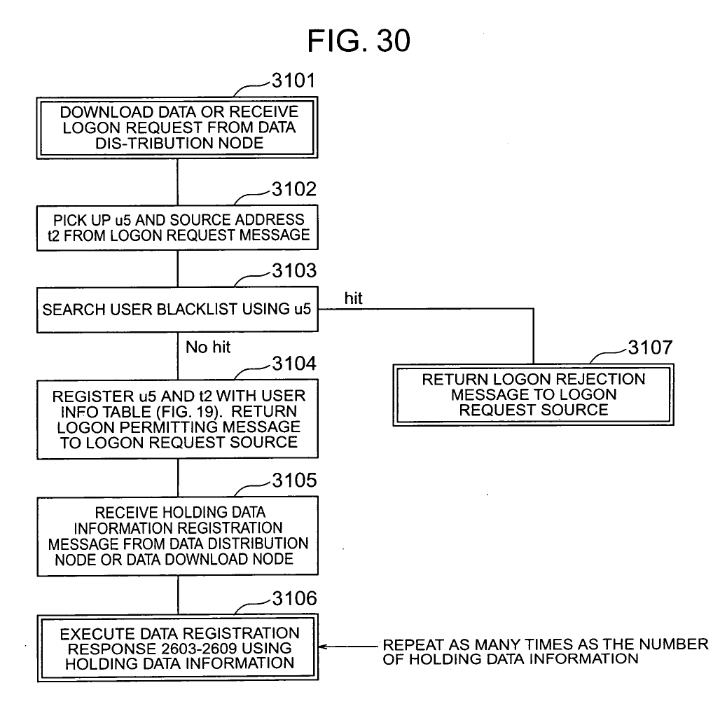

FIG. 4 shows a configuration of the data download node 110 (G). In the main memory there are a data distribution network logon function 401, an index lookup request function 402 and a data download function 403. Each of these functions will be explained using the flow chart of FIG. 29, FIG. 6 and FIG. 7. A data transfer function 404 redistributes downloaded data stored in the data storage area 412, according to a request from other data download nodes. A data tampering detection function 405 is a part of the data download function 403 and checks that the downloaded data is the same as the data distributed by the distributor. In a hard disk there are an index holding node list 411, a data storage area 412 and a message buffer 413. They communicate with other nodes through a network interface 421.

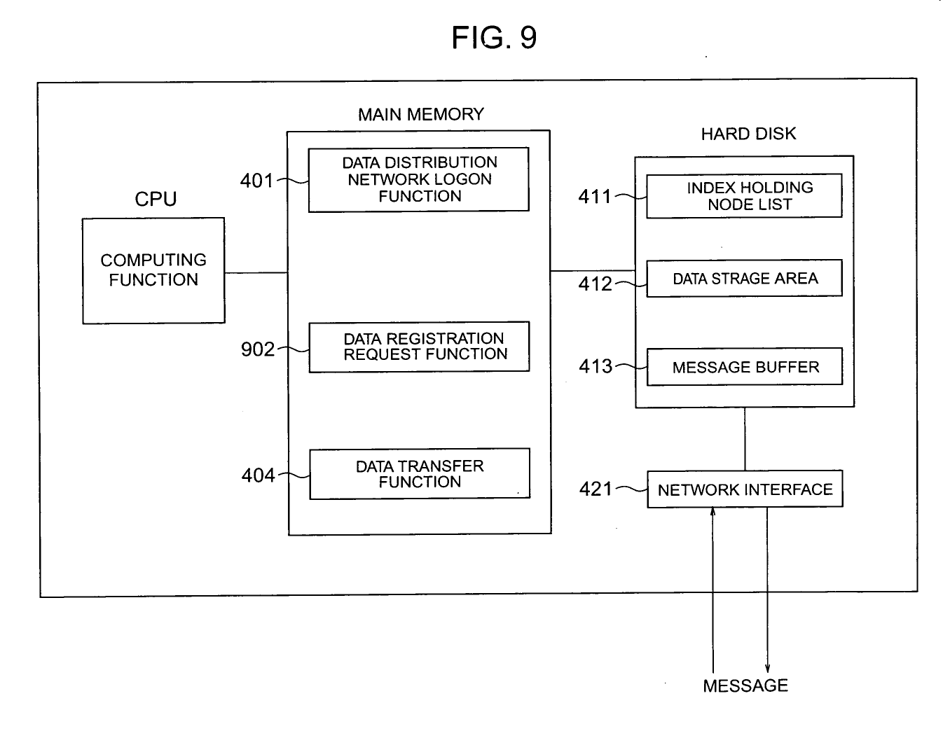

FIG. 9 shows an internal configuration of the data distribution node 111 (D1). In a main memory there are a data distribution network logon function 401, a data registration request function 902 and a data transfer function 404. What resides in the hard disk is the same as those of G. The logon function and the data transfer function are the same as those of the data download node. The data registration request function 902 will be explained in the flow chart of FIG. 10. The network interface function is the same as that of G.

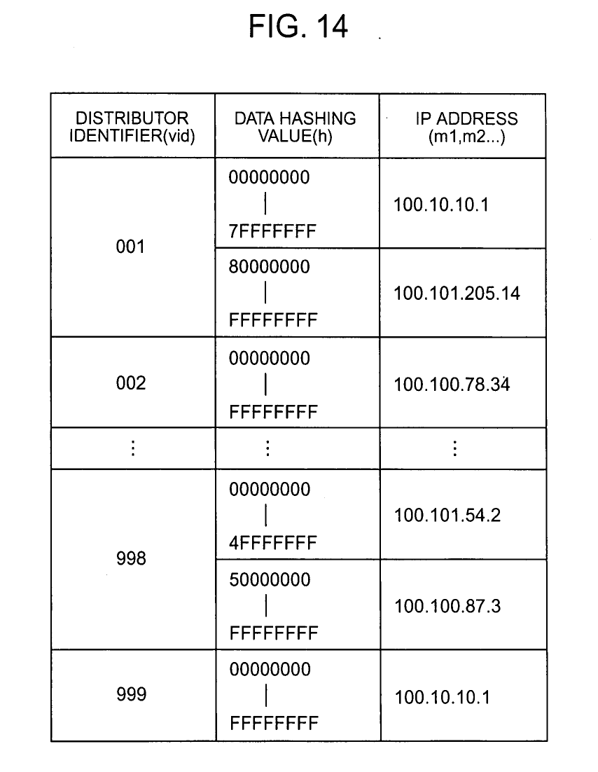

FIG. 12 shows an internal configuration of an index holding node 113 (M1). In a main memory there are a lookup response function 1201, a data transfer recording function 1202, a data registration response function 1203, an intra-network index lookup function 1204, an intra-network index registration function 1205, a logon acceptance function 1206 and an index publishing function 1207. In a hard disk the index holding node M1 has an index 1211, an index holding node IP address table 1212, a user info table 1213, a blacklist 1215 in the index holding node, a signature holding node IP address table 1216, a signature table 1217 showing a signature of data that is registered and being distributed, a user statistics table 1218 showing the number of times that the user has performed downloading, and a message buffer 413. The user info table 1213 shows a correspondence between uid as key and vid, IP address and a distributor identifier list that can be downloaded by the user. The network interface function is the same as that of G. The index publishing function publishes to all data downloaders a pair of vid and NAME among the indices of FIG. 13. One publishing method may involve preparing a page for each vid and putting a list of NAME's on the page. This function may be provided by a web server such as apache. vid's and NAME's to be published may be collected from all index holding nodes and published by a small number of particular index holding nodes. In that case, IP addresses of the small number of index holding nodes are kept in the data download node in advance. Alternatively the index pairs may be published by all index holding nodes. In that case, the data download node can appropriately select an IP address from FIG. 5. To collect the distributor identifiers and the data names from all index holding nodes requires referencing FIG. 14 and then requesting all the IP addresses found there to inform the distributor identifiers and data names.

FIG. 5 is an example of the index holding node list 411 kept by G or D1. IP addresses of some index holding nodes are kept here in advance and used by the index lookup request function 402. For example, attempts may be made to access the IP addresses in the order of priority and communicate with a node successfully reached.

FIG. 13 is an example of an index 1211 kept in M1. Each index entry includes, as an attribute for each data, at least a distributor identifier (vid) and a hash value (h) of the data name as search key. Values included in each entry are the data name (NAME), an IP address of a data distribution node, a signature of the data (f), a list of user identifiers of the users who have downloaded the data, a list of IP addresses of the data download nodes that have downloaded the data and are still holding it, and the total number of times that the data has been downloaded. During the lookup response processing 1201, this table is referenced to look for an IP address of the node that has the data. When there are two or more IP addresses, it is possible to select and return one them or to return the list of all IP addresses. If no IP addresses exist, an IP address of the data distribution node is returned. Because the response includes a data name, the lookup requester can check if the data name agrees. The signature is used to determine whether data has been tampered with when the lookup requester downloads the data. When a user of the node holding the data logs out from the data distribution network, the IP address is deleted from the table. A user identifier of the user who has downloaded the data is used to track a transfer route of the data for the management purpose. By using vid as a lookup key, data can be acquired even if a file name is not known as long as a data distributor is known. Further, the data download frequency may be disclosed to a data distributor as statistics information so that the data distributor can do a marketing analysis of a user's data downloading trend.

FIG. 14 is an example of an index holding node IP address table 1212 kept in M1. This table shows IP addresses of the index holding nodes and a range of index information managed by each index holding node. During the lookup response processing 1201, this table is referenced to find an IP address of an index holding node that holds the index.

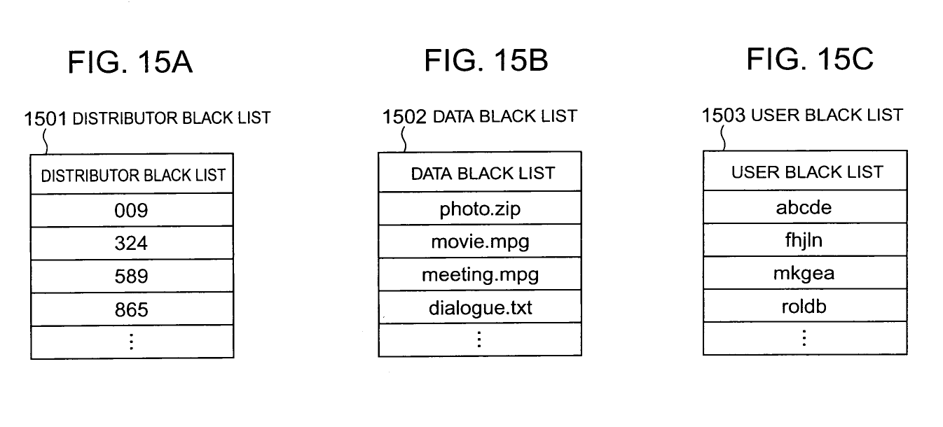

FIG. 15A-15C show examples of blacklists 1215 kept in M1. During the logon acceptance process 1206, the index holding node 113 refers to the user blacklist 1503 (FIG. 15C) and decides whether or not to permit or reject the user logon. With this procedure, malicious users on the blacklist can be rejected. Further, during the lookup response process 1201, the index holding node 113 returns a reply that the data, if listed on the data blacklist 1502 (FIG. 15B), does not exist. This procedure prevents those malicious data on the blacklist, which one wishes to block their redistribution, from being downloaded. Further, during the data registration response process 1203, the index holding node 113 refers to the distribution blacklist 1502 (FIG. 15A) and decides whether or not to permit or reject the new data distribution. This is done to prevent probably malicious data from being distributed by a blacklisted, malicious data distributing user. These blacklists are empty at first and their contents are added progressively as the data distribution network is operated. Some content adding methods are shown in FIG. 8. When a user identifier is added to the user blacklist, one method may be to forcibly make the user log out to exclude him from this data distribution network.

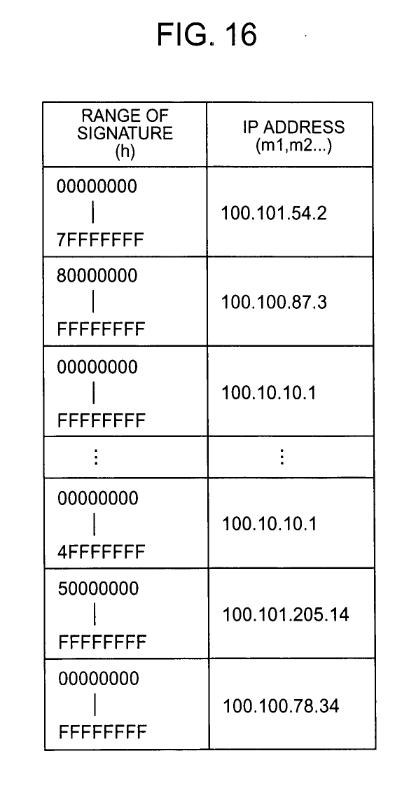

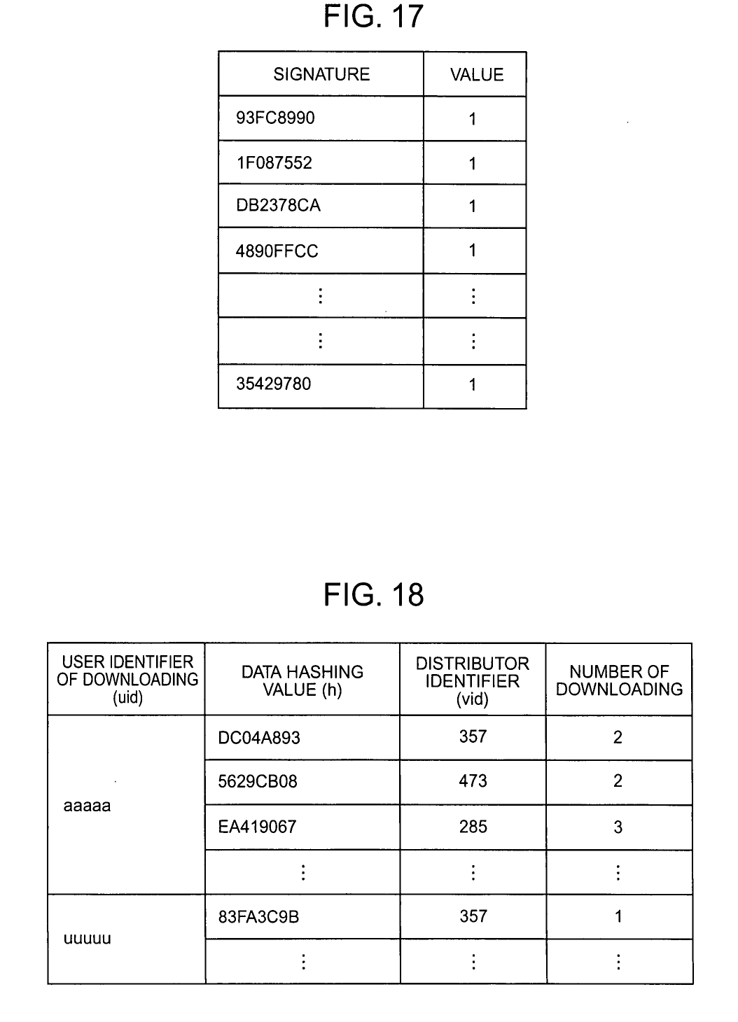

FIG. 16 and FIG. 17 are an example of the signature holding node IP address table 1216 and an example of the signature table 1217. This is used to check whether data that is going to be distributed has already been distributed. That is, this is used by M1 during the data registration response process 1203. FIG. 17 is a table showing whether data having a particular signature exists. The value is set to 1 when the data is registered. When the table is searched later, those data with the value of 1 are taken to be already existent. Depending on the table configuration, the decision can also be made by checking whether the table has only a left-side column containing a signature with no right-side column. FIG. 16 is a table showing IP addresses of index holding nodes that keep a particular range of signatures shown in FIG. 17. By using the signature, it is possible to determine if data of interest is already registered. For example, the signature provides the following advantage. When a user attempts to register data, he can recognize that the same data that he produced in the past is already registered by other person. And he can make a protest to that person.

FIG. 18 is an example of the user statistics table 1218 kept by M1. This table records a history of which data downloader has downloaded which data. Normally, this table is open to data distributors with user identifiers kept secret. A data distributor can analyze this history to know which data is popular among users.

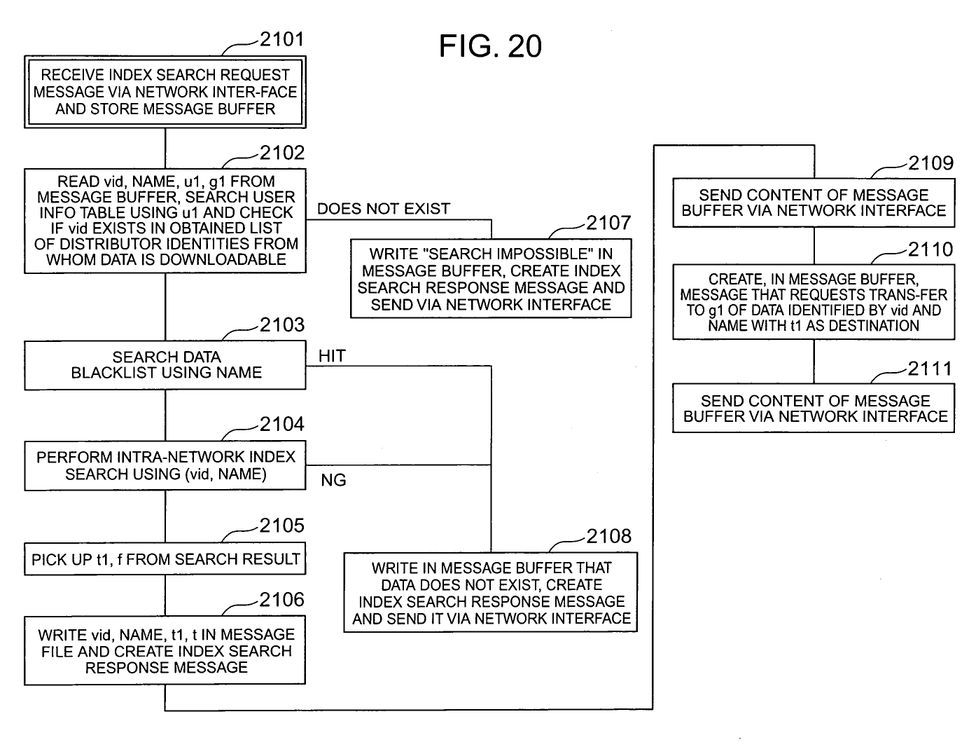

FIG. 19 is an example of the user info table 1213 kept by M1. During the data registration response process 1203, the user who is going to distribute data refers to this table to download distributor identifiers to see if they have the right to distribute. This table shows an association among uid as a key, vid, IP address and a list of identifiers of distributors from which to download data. uid and vid are set by the administrator of the data distribution network when the user signs a service contract. The IP address is registered during the logon acceptance process 1206. As for the distributor identifier, before the user downloads data from a distributor, when the user gains a data downloading permission directly from the data distributor or indirectly through the system administrator, a distributor identifier for the data distributor is set. This permission may be given by adding to a page on a web site showing a list of vid and distribution data a link to a page where the user registration is performed for data download. With this process, when a data distributor wants to put a limitation on data downloaders, he can select a user he gives a data downloading permission. It is also possible to conceal information that the data of interest exists from other than the user given a data downloading permission. Although this will be explained by referring to FIG. 20, it is noted that, instead of being published on the web, vid and data name must be notified to individual users who are granted a data download permission. If no restriction is put on the data downloaders, the corresponding column is left empty or a special characters such as “*” may be entered.

FIG. 6 is a flow chart for the index lookup request function of G and FIG. 7 is a flow chart for the data download function of G. In an index lookup request 201, the user first downloads vid and NAME (601). As described in FIG. 5, the user selects m1 (602) and generates an index lookup request message including vid and NAME in a message buffer 413 (603). This message is sent to M1 (604) and the user waits for a response (605). Upon receiving a reply message from M1, the index lookup request function checks the content (606) and, if t1 and f exist, inputs them along with vid and NAME into the data download function 403 (607). If the reply message does not include an IP address, the index lookup request function notifies the user that the data of interest does not exist (608).

The data download function 403, when it receives (vid, NAME, f, t1) from the index lookup request function 402 (701), waits for data to be received and stores it in the data storage area (702). A check is made as to whether the data received has been tampered with, by the data tampering detection function 405. More precisely, a signature f2 is computed from the entire data received. It is assumed that the entire data distribution network 120 requires a single hash function and that it is set in advance. Examples of hash functions include SHA1 (ftp://ftp. rfc-editor.org/in-notes/rfc3174.txt) and MD5 (ftp://ftp.rfc-editor.org/in-notes/rfc1321.txt). Next the data download function compares f and f2 and, if they completely agree, determines that the data is not tampered with and notifies the user of a completion of the data downloading (704). If not, it is decided that the data has been tampered with and a data tampering notification (vid, NAME, t1) is made to M1 (705). At the same time, a data download failure is notified to the user (706).

FIG. 11 is a flow chart for the data transfer function 404 of T. Upon reception of a data transfer request 213 from G (1101), the data transfer function reads g1, which is an IP address of G, vid and NAME from the message buffer (1102). Next, the function reads the data specified by NAME from the data storage area 412 and sends it to G (1103). After the data transmission is complete, the function notifies a data transfer completion notification (vid, NAME, d1, g1) 205 to M1 (1104).

FIG. 20 is a flow chart for the lookup response process 1201 in M1. First, upon receiving an index lookup request 201 from G through a network interface, the lookup response function stores it in the message buffer 1219 (2101). From the message buffer it reads a distributor identifier (vid), a data name (NAME), a user identifier (u1) of the user who requested the lookup and an IP address of the user terminal and searches through the user info table (FIG. 19) using u1 (2102). If vid is not found among the acquired downloadable distributor identifiers, the function replies to the lookup requester that the lookup is rejected (2107). As a result, the user not granted a data download permit cannot download the data. In that case, if vid and NAME are made public, the data downloader may attempt to gain a data download permit in some way. However, if vid and NAME are not made public, even if the user intentionally makes a search, the search rejected state can hide the information itself about whether the data of interest exists.

Next, the lookup response function 1201 searches through the blacklist 1215 using NAME (2103). If the search does not have any hit, the function executes an intra-network index lookup using vid and NAME (2104). This search will be detailed by referring to FIG. 21 and FIG. 22. If the search result is OK, t1 and f can be obtained (2105). Next, the function writes vid, NAME, t1 and f in the message buffer and creates an index lookup response 202 (2106). If the step 2103 hits a data blacklist or if the step 2104 fails in the search, the function returns an index search response that the distributor with its identifier of vid does not distribute data specified by NAME (2108). As a result, if the data actually exists, the user cannot obtain data location information and therefore the data. Since the data listed on the blacklist in particular are malicious data, it is desired that they be kept unavailable. The reason that the location information is not deleted is that there is a case where a user terminal having the data of interest will be tracked for a management purpose. Next, the content of the message buffer is returned to G through the network interface (2109). A message instructing T1 to send data specified by vid and NAME to G is created (2110) and sent to T1 (2111).

FIG. 21 and FIG. 22 are flow charts for index search in the index holding network 121. M1 receives vid and NAME from the lookup response function 1201 (2201). NAME is entered into a predetermined hash function to obtain a hash value (simply referred to as h) (2202). Next, using vid and h, the index search process searches through the index holding node IP address table 1212 to obtain an IP address (referred to as m2) of an index holding node (referred to as M2) that manages an index entry of data specified by vid and h (2203). An index lookup request (vid, h) is sent to m2 (2204). t1 and f, obtained from M2, are returned to the lookup response function 1201 (2205).

When M2 receives an index lookup request (vid, h) from M1 (2301), the index search process searches for an index 1211 using vid and h (2302). When the search result is OK, t1 and f thus obtained are returned to M1 (2303). If the search result is no good, NG is returned to M1 (2304).

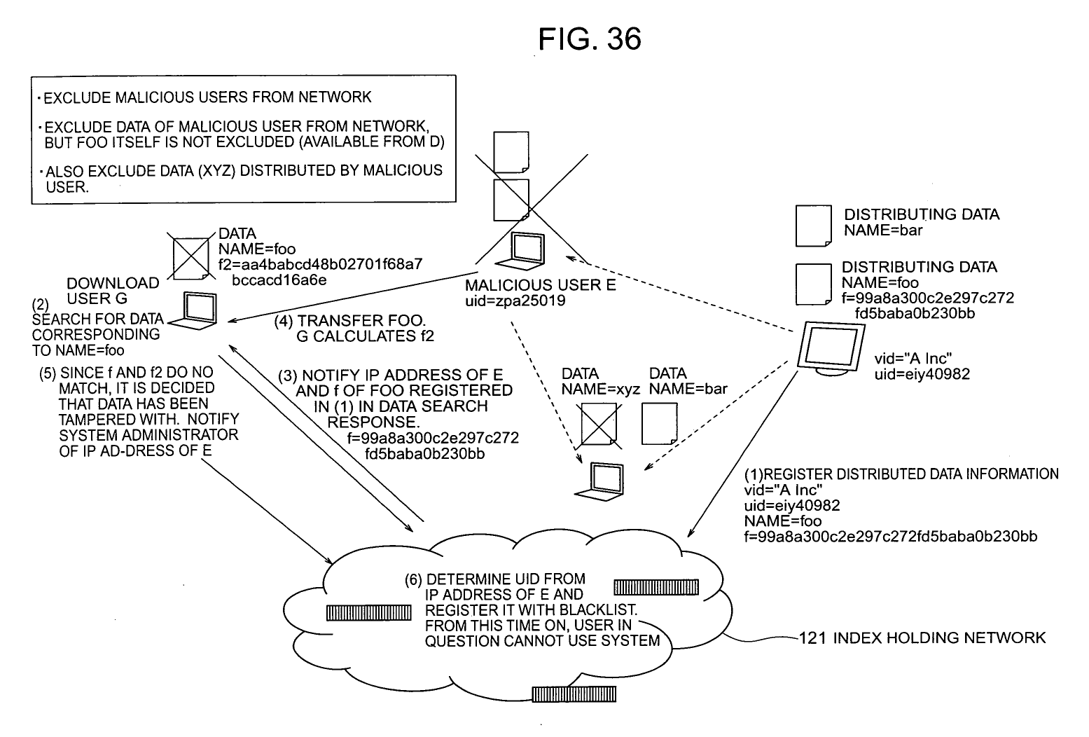

FIG. 8 is a flow chart for generating a blacklist 1215 in M1. When it receives a data tampering notification (vid, NAME, t1) 206 from G (801), M1 searches through the user info table (FIG. 19) using t1 to obtain a user identifier u2. This u2 is registered with the user blacklist in all index holding nodes. At this time, if vid corresponding to u2 exists, vid is registered with the distributor blacklist in all index holding nodes (804). Next, the index is searched by using vid to gather all associated data names (805). Then, these data names are registered with the data blacklist in all index holding nodes. With these data names registered with the user blacklists, the user (user identifier u2) who has tampered with data will get rejected from the data distribution network when he or she logs on next time. Further, registering the user with the distributor blacklist can block the data distribution immediately. Then, by registering with the data blacklist all data names that the user u2 has distributed in the past using the data distributor identifier vid, it is possible to prevent other users from acquiring these data. This process therefore does not only excludes malicious data tampering users but also reject those data which the user has distributed in the past and are highly likely to be malicious. The above process is outlined in FIG. 36. If a user E is found to have tampered with data foo distributed by a user D, the user E and the data xyz distributed by E are rejected from the network but foo itself is not excluded.

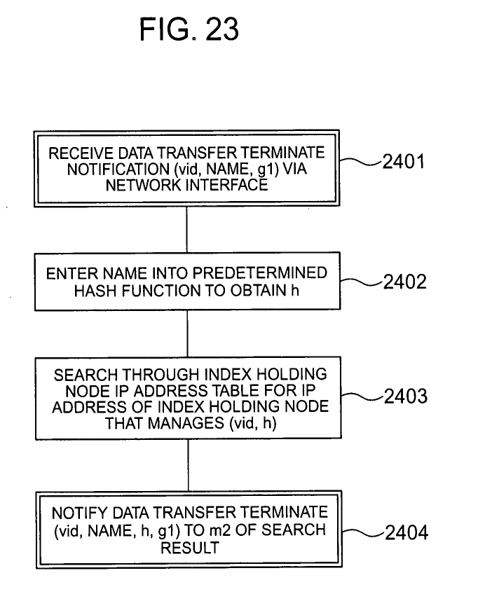

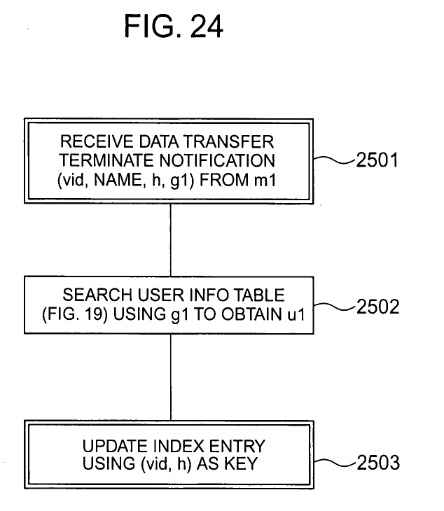

When a data distributor makes a transfer prohibit request (vid, NAME) (810), NAME is registered with the data blacklist of all index holding nodes (811). As a result, for an index lookup request for NAME, a lookup response (2103 in FIG. 23) is returned saying that there is no such data, making it impossible for the user to download the data. In this way the transfer prohibit request from the data distributor is met.

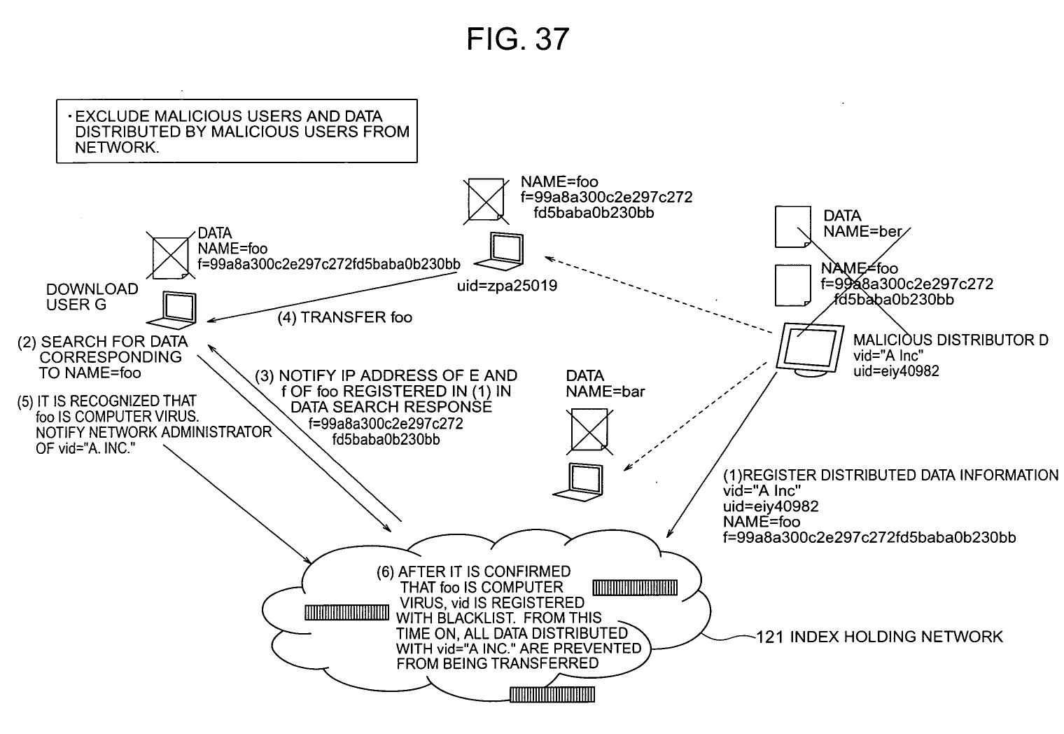

Further, when a user notifies that data with NAME=foo and vid=v is a computer virus (820), v is registered with the distributor blacklist in all index holding nodes (821). Next, the index is searched using v to collect all the associated data names (822). These data names are registered with the data blacklist in all index holding nodes (823). This prohibits a further data distribution by the user who have distributed the data foo, and can also prevent a transfer of the already distributed data. This process is outlined in FIG. 37. When a user G notifies that the data foo is a computer virus, the administrator, after confirming this, prohibits the transfer of foo and a further data distribution using the foo's distributor identifier “A, Inc.” as well as the data bar that “A, Inc.” has distributed in the past. As described above, if malicious data such as computer virus should be distributed, damages can be prevented from spreading, thereby allowing the users to rest assured.

FIG. 23 and FIG. 24 are flow charts for the function of recording data transfers to the index holding network. When M1 receives a data transfer terminate notification (vid, NAME, g1) 205 from T through the network interface 421, it stores the message in the message buffer (2401). The data transfer recording function retrieves vid and NAME from the message buffer and enters NAME into the predetermined hash function to obtain a hash value h (2402). Next, the function searches through the index holding node IP address table for an IP address of the index holding node that manages (vid, h) (2403). Here, M2 is selected as an index holding node and its IP address is taken to be m2. The function sends a data transfer terminate notification (vid, NAME, h, g1) with destination address set to m2 (2404).

M2 receives the data transfer terminate notification (vid, NAME, h, g1) from M1 (2501) and searches through the user info table (FIG. 19) using g1 to get u1. Using vid and h, the function updates the index 1211 (2503). Here, u1 is added to the column of the acquired user identifier, g1 is added to the holding node IP address column, and the total number of times is incremented by one.

FIG. 10 is a flow chart for the data registration request function 902 of D1. First, the function receives vid and NAME from a user (1001). At this time, the user stores the data to be registered in the data storage area 412. Next, using the predetermined hash function, the function computes a signature f from the entire data. The function selects one index holding node from the index holding node list 411 (here it is assumed that M1 is selected) (1003). Then, a data registration request 301 including vid, NAME, f, data distributor's user identifier (u3) and data distribution node IP address (d1) is created in the data buffer with its destination set to the IP address (m1) of M1 (1004). This is sent to M1 (1005) and the function waits for a reply from M1. When it receives a data registration response 302 via the network interface 421, the function stores it in the message buffer (1006) and checks the response (1007). If the registration is OK, the function informs the user that the data distribution has been successfully completed (1008). If not, a data distribution failure is notified to the user (1009).

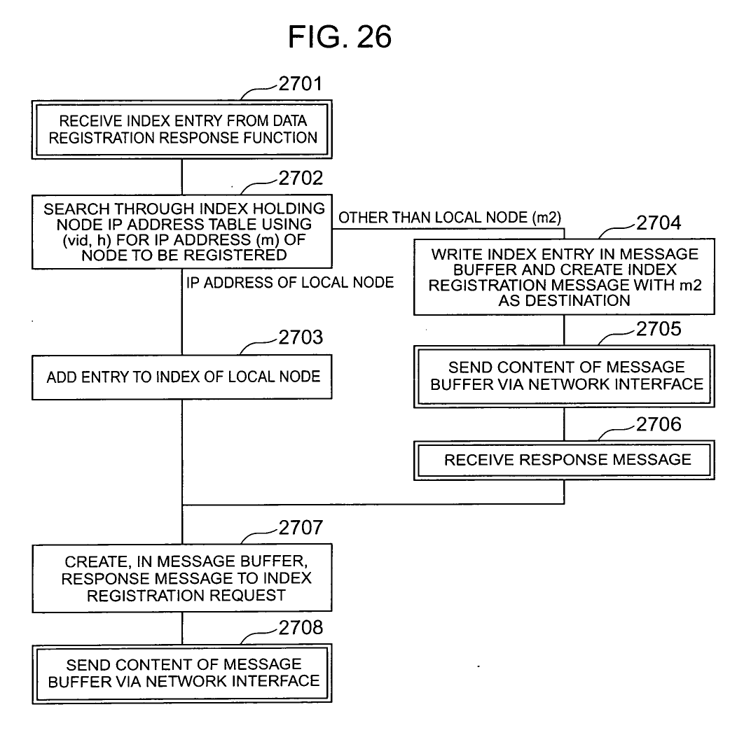

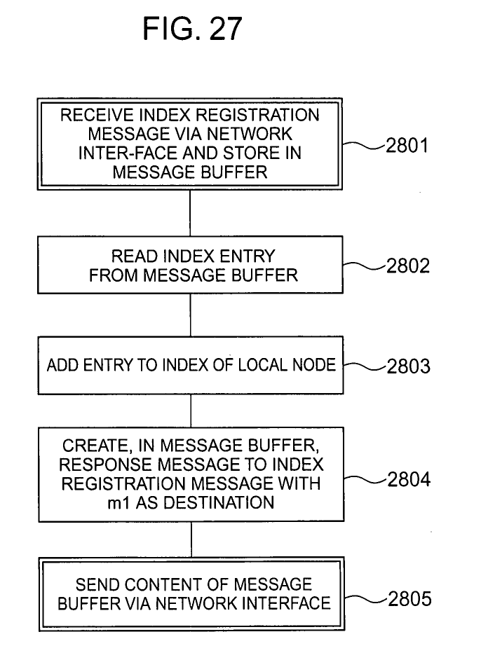

FIG. 25 is a flow chart for the data registration response function of M1. First, the function receives a data registration request 301 from D1 and stores it in the message buffer (2601). It then picks up vid, NAME, f, u3 and d1 from the message file (2602). Next, using u3, the function searches through the user info table 1213 to check if vid agrees, which means that the user has a right to distribute the data (2603). If vid agrees, the function searches through the blacklist 1215 using vid to check that the vid is not listed on the distributor blacklist (2604). If the procedure 2603 should fail or if the procedure 2604 has a hit, they are deemed as a data registration failure and the function proceeds to the procedure 2707 of FIG. 26. With this process it is possible to prevent those data on the blacklist, including those owned by a malicious user that should not be redistributed, from being downloaded. Next, NAME is entered into the predetermined hash function to obtain h (2605). Using this h, the signature table 1217 is searched (2606). If there is a hit, there is a possibility that the data is already registered by other person. So, a registration suspension is notified to the data distributor (more specifically, a warning is indicated on GUI) (2607). As described in FIG. 16, in the case of the data that the user himself has created in the past, this warning may help the user become aware that his data was registered by other user, thus allowing him to make a protest to the other user. If there is no hit, an index entry is created using vid, NAME, h, f, u3 and d1 (2608). Referring to FIG. 13, vid corresponds to a distributor identifier, NAME a data name, h a search key, u3 a user identifier, d1 an IP address and f a signature. Since the registration has just been finished, the user identifier of the user who has downloaded the data and the IP address of the node that has downloaded the data are empty. And the total number of times is 0. Then, using this index entry, the function executes an intra-network index registration 303 (2609). This will be detailed by referring to FIG. 26 and FIG. 27.

FIG. 26 and FIG. 27 are flow charts for the intra-network index registration. When M1 receives an index entry by the data registration response function 1203 (2701), it references the index holding node IP address table 1212 using vid and h to find an IP address of the index holding node that manages vid and h (2702). If the IP address obtained is m1, the index entry is newly added to the index 1211 (2703). If the IP address obtained is m2 of M2, an index registration 303 including an index entry is created in the message buffer with m2 as the destination IP address (2704) and is sent via the internet interface (2705). In the procedure 2707, if a response message 304 is received from M2 (2706), a data registration response 302 is created in the message buffer using the content of the response message received. When the procedure 2703 is completed, a data registration response 302 having the procedure result as its content is created in the message buffer. Further, if the procedure 2603 of FIG. 25 fails or if the procedure 2604 has a hit, a data registration response 302 is created in the message buffer, indicating that the data registration has failed. As a last step, this message is sent to D1 via the network interface (2708).

M2 receives an index registration from M1 and stores it in the message buffer (2801). M2 picks up an index entry from the message buffer (2802) and adds it to the index 1211 (2803). An index registration response 304 with m1 as a destination is created in the message buffer (2804) and sent via the internet interface (2805).

FIG. 29 is a flow chart of the data distribution network 120 logon function, commonly used by the data download node 110 and the data distribution node 111 (simply referred to T2). Immediately after the node is started, one index holding node is selected from the index holding node list 411 (3001). Here let us assume that M1 (its IP address is m1) is chosen. a logon request (u5) is sent to M1 (3002). u5 is a user identifier of the data downloader or data distributor who is going to log on. Upon receiving a logon OK response 2902 from M1, the logon function creates holding data information (vid, NAME, f, u5, t2) for all data stored in the data storage area (3003). Here, t2 is an IP address of T2. Next, these holding data information are gathered to create a holding data information registration 2903, which is then sent to M1 (3004).

FIG. 30 is a flow chart for the logon acceptance function 1206 in M1. The function receives a logon request 2901 from T2 (3101), picks up u5 (3102) and search through the blacklist 1215 using u5 (3103). If there is hit, a logon response 2902 that rejects the logon is created and returned to t2 (3107). If there is no hit, a logon response 2902 permitting the logon is created and returned to t2 (3104). By rejecting the logon of a malicious user listed on the blacklist, further damages can be forestalled. When it receives a holding data information registration 2903 from T2 (3105), the function executes an intra-network index registration using the holding data information (3106). The detail of this process is similar to FIG. 26 and FIG. 27. This process is repeated the same number of times as the number of the holding data information.

In the embodiment described above, a data downloader can determine before downloading whether the data he is going to download is the desired data by confirming the authenticity of the data. Therefore, the data downloader can be protected against from unknowingly downloading malicious data and the network administrator can provide data downloaders with enhanced security.

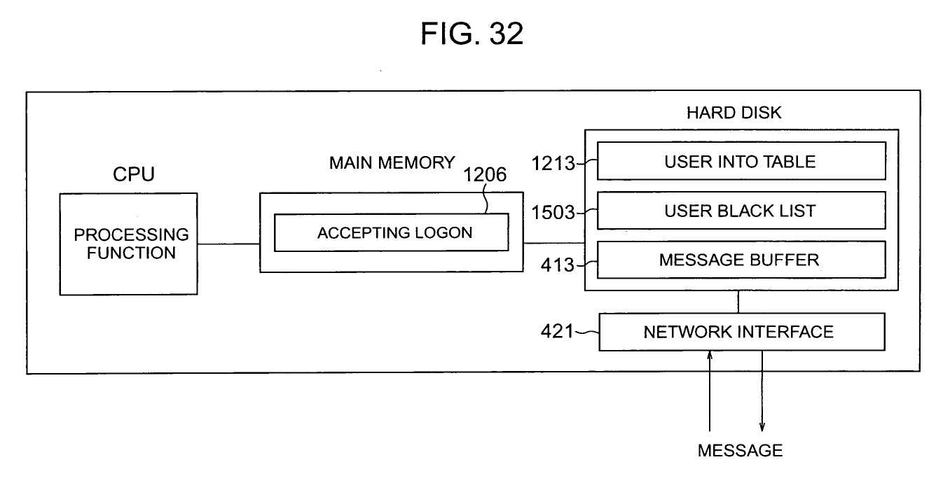

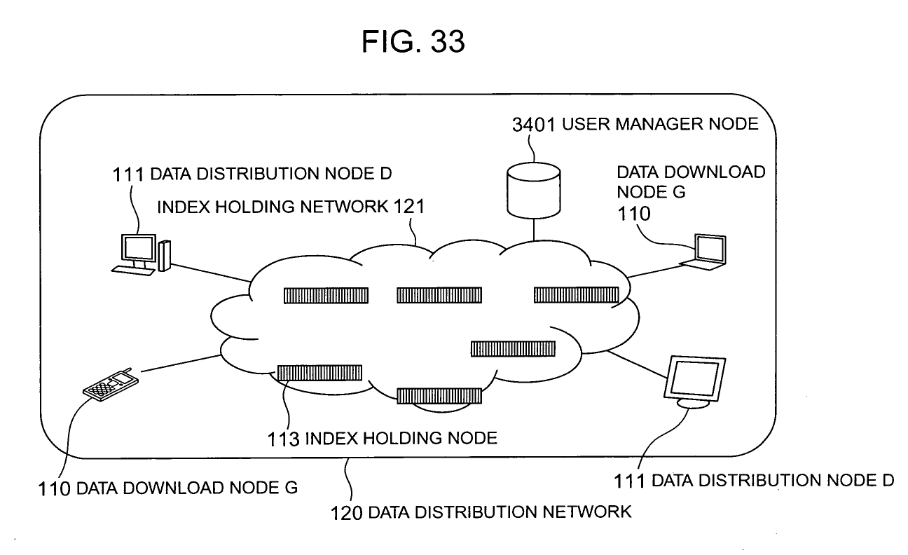

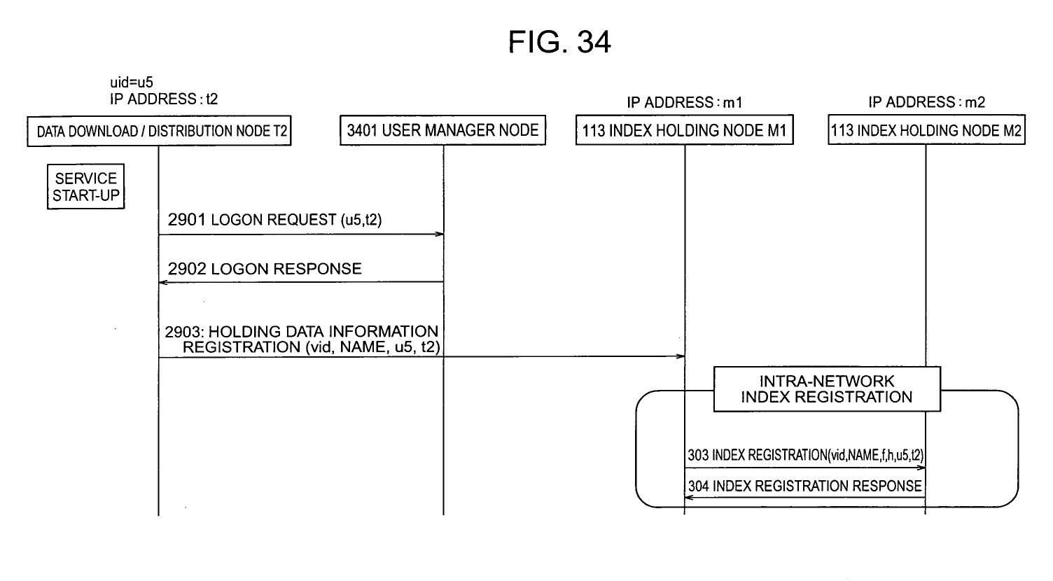

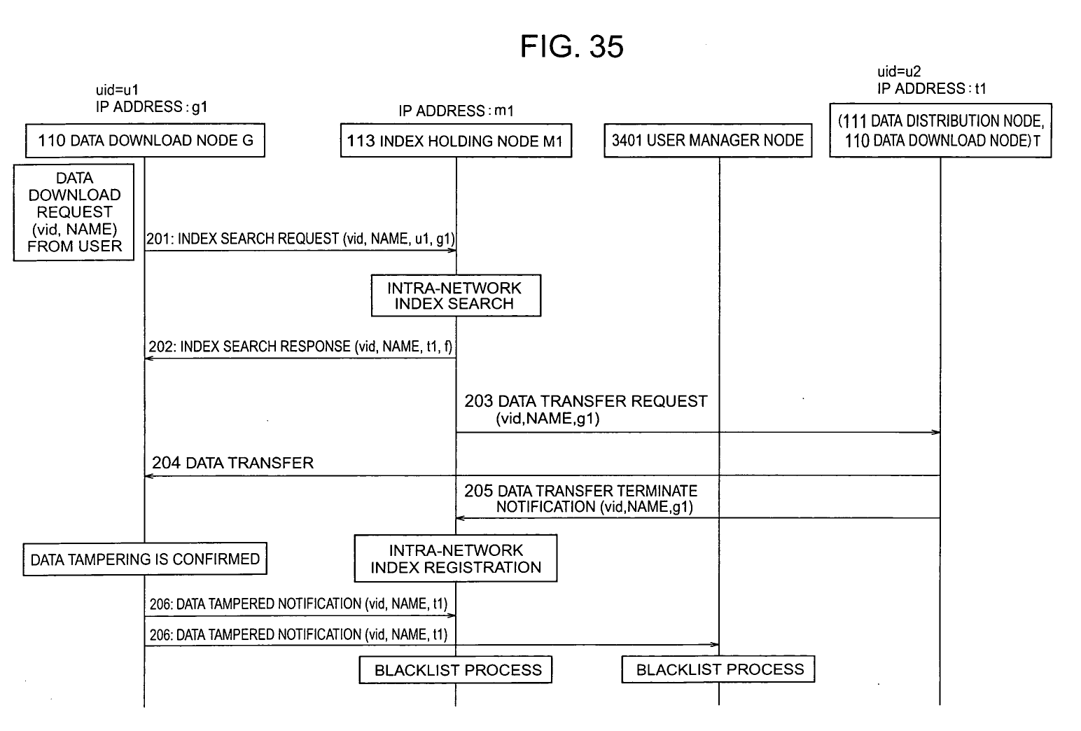

A second embodiment according to this invention configures the logon function of the index holding node shown in FIG. 12 as a separate node. Among the logon acceptance function 1206, user info table 1213 and blacklist 1215, the user blacklist 1503 is moved to a user management node 3401 shown in FIG. 32. The network configuration is shown in FIG. 33. An IP address of the user management node is set in the data download node 110 and the data distribution node 111 in advance. In this case, the sequence of FIG. 28 changes to that shown in FIG. 34, with the messages 2901, 2902 processed by the user management node. The steps 3001, 3002 in FIG. 29 select the user management node instead of the index holding node. Further, steps 3101, 3102, 3103, 3104, 3107 in FIG. 30 are processed by the user management node. A step 206 in FIG. 2 sends the data tampering notification also to the user management node as shown in FIG. 35. This embodiment allows the use of the already existing user management node when this data distribution network service is combined with other services.

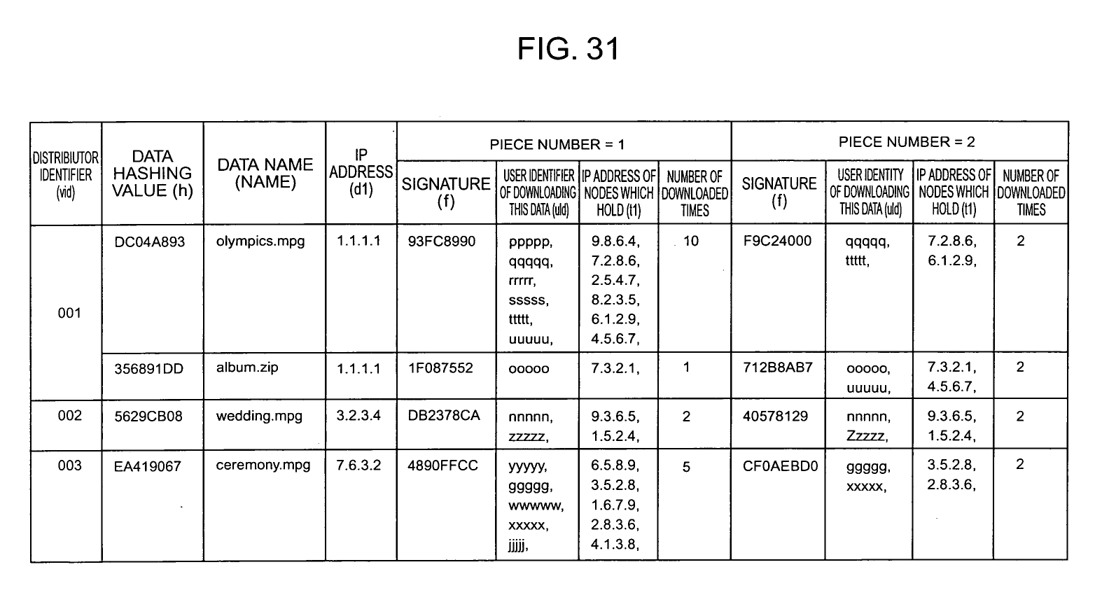

FIG. 31 is an index 1211 in a third embodiment according to this invention. In this embodiment the data to be distributed is divided into two pieces. As shown in FIG. 31, the signatures, the user identifiers of the downloading users, the IP addresses of the data downloading nodes and the total number of times of downloading are managed for each data piece. In this embodiment, the data downloading must be executed for each piece. That is, in FIG. 2 the index lookup response 202 includes destination IP addresses for two pieces. Therefore, the data transfer request 203 is also transmitted to two different destinations and the data transfer message 204 is also received from the two destinations. Further, the data tampering notification 206 and the data transfer terminate notification, too, are each sent for two pieces. As for the registration of distribution data, since the registration is performed for each data, not for each piece, there is no change in the sequence in FIG. 3. It is noted, however, that the index in FIG. 31 is changed and the signature f contained in the data registration request exists in number equal to the pieces because the signature is computed for each data piece. All changes entailed by the division of data in two pieces have been described above.

The above discussion similarly applies to where the number of divided data pieces increases to more than three. The number of divided pieces can be changed for each data. By dividing data in a plurality of pieces as in this embodiment, it is possible to download a plurality of pieces at one time, shortening the time it takes to acquire one data.

It should be further understood by those skilled in the art that although the foregoing description has been made on embodiments of the invention, the invention is not limited thereto and various changes and modifications may be made without departing from the spirit of the invention and the scope of the appended claims.

1. A data distribution system comprising at least one data distribution node holding data, at least one data download node and one or more index holding nodes holding location information on the data, the data distribution system exchanging data between the data download nodes or between the data download nodes and the data distribution nodes;
wherein the data distribution node comprises means for registering with the index holding node an attribute of data to be distributed including a unique distributor identifier assigned in advance;
wherein the data download node comprises means for requesting a search for a location of the data by using the distributor identifier and a data name of the data to download the searched data;
wherein the index holding node comprises means for holding a data blacklist which, when the data downloaded by the data download node is determined to be malicious data, manages that data, and which makes to the search for the data listed on the data blacklist, a reply that the data does not exist.

2. A data distribution system according to claim 1,
wherein the index holding node comprises:
means for holding a corresponding relation between the distributor identifier and a user identifier of the distributor who distributes the data;
means responsive to registering of the attribute of the data to be distributed, checking whether a correspondence between the distributor identifier sent from the data distribution node and the user identifier agrees with the correspondence held in the corresponding relation;
means for managing the location information on the distributed data by the distributor identifiers; and
means for searching the location of the distributed data by the distributor identifier and the data name.

3. A data distribution system according to claim 1,
wherein the index holding node comprises:
means for downloading a signature of the data notified from the data distribution node and held in the index holding node during the data registration;
means for creating a signature of the downloaded data;
means for comparing the two signatures;
means for discarding the downloaded data if the two signatures do not match; and
means for notifying the distributor identifier representing the data distributor, the data identifier and a user identifier of a downloader to the index holding node.

4. A data distribution system according to claim 3,
wherein the index holding node comprises:
means for holding a distributor blacklist which manages the distributor identifier obtained by the notification; and
means for rejecting the data registration with the index holding node by the user corresponding to the distributor identifier listed on the distributor blacklist.

5. A data distribution system according to claim 3,
wherein the index holding node comprises:
means for holding a user blacklist which manages the user identifier obtained by the notification; and
means for rejecting a logon to the data distribution system by the user listed on the user blacklist.

6. A data distribution system according to claim 5,
wherein the data distribution node and the data download node comprises means for notifying the index holding node of the distributor identifier of the data, the data name and the user identifier of a data destination when the data held in the data distribution node and the data download node is transmitted to another data download node;
wherein the index holding node comprises means for recording and keeping, for each notified distributor identifier, the data identifier, the user identifier and a frequency of data transfer.

7. A data distribution system according to claim 3, including means for also registering the data name notified from the data distribution node with the data blacklist.

8. A data distribution system according to claim 1, wherein the data to be distributed is divided into two or more pieces an attribute of the data to be distributed are registered in the index holding node, for each data pieces; and the data one piece is downloaded at a time by the data download node.

9. A data distribution system according to claim 8,
wherein the attribute of the data includes:
at least a signature notified from the data distribution node during the data registration; and
the user identifier of the user who has downloaded the piece and an IP address of the node that has downloaded the piece.

10. A data distribution system according to claim 9,
wherein the attribute of the data includes the number of times that the piece has been transmitted.

11. A data distribution system according to claim 3, further including a user management node;
wherein the notification is also given to the user management node;
wherein the user management node comprises:
means for holding a user blacklist to manage the user identifier obtained by the notification; and
means for rejecting a logon to the data distribution system by the user listed on the user blacklist.

12. An index holding node for holding data location information, the index holding node being connected to at least one data distribution node holding data and at least one data download node via a data distribution network that exchanges data between the data download nodes or between the data download nodes and the data distribution nodes;
wherein the index holding node comprises:
means for holding an attribute of the data to be distributed which is notified from the data distribution node and which includes a unique distributor identifier assigned to the data distribution node in advance;
means for making a request for searching the location of the data using the distributor identifier and a name of the data requested by the data download node and notifying the searched data location to the data download node; and
means for holding a data blacklist that manages the data when the data downloaded by the data download node is decided to be malicious data and to reply to the search for the data listed on the data blacklist that the data of interest does not exist.

13. An index holding node according to claim 12, further comprising:
means for holding a correspondence between the distributor identifier and the user identifier of the distributor who distributes the data;
means responsive to registering of the attribute of the data to be distributed, for checking whether a correspondence between the distributor identifier sent from the data distribution node and the user identifier agrees with the correspondence held in the means;
means for managing the location information on the distributed data by the distributor identifier; and
means for searching the location of the distributed data by the distributor identifier and the data name.

14. An index holding node according to claim 12, further comprising:
means for holding a signature of the data notified from the data distribution node during the data registration;
means for notifying the signature to a search request from the data download node; and
means for holding the distributor identifier representing the distributor of the data, an identifier of the data identifier and the user identifier of the downloader when the data download node compares the signature with the signature created from the downloaded data and found that the two signatures do not match.

15. An index holding node according to claim 14, further comprising:
means for holding a distributor blacklist that manages the distributor identifiers obtained by notification; and
means for rejecting the data registration by the user corresponding to the distributor identifier listed on the distributor blacklist.

16. An index holding node according to claim 14, further comprising:
means for holding a user blacklist which manages the user identifier obtained by the notification; and
means for rejecting a logon to the data distribution system by the user listed on the user blacklist.

17. An index holding node according to claim 12, further comprising:
means responsive to transmission of the data held by the data distribution node and the data download node to another data download node, for recording and holding, for each distributor identifier, the distributor identifier of the data notified from the data distribution node and the data download node, the data name, the user identifier of a data transmission destination and the number of times that the data was transferred.

18. An index holding node according to claim 12, further comprising:
means for further registering with the data blacklist the data name notified from the data distribution node.

19. A data distribution system having at least one data distribution node holding data, at least one data download node and one or more index holding nodes holding location information on the data, the data distribution system exchanging data between the data download nodes or between the data download nodes and the data distribution nodes;
wherein the data distribution node comprises means for registering with the index holding node an attribute of data to be distributed including a unique distributor identifier assigned in advance;
wherein the data distribution node comprises means for searching for a location of the data by using the distributor identifier and a data name of the data and acquire the searched data;
wherein the index holding node comprises:
means for holding a distributor identifier list in which the distributor identifier is associated with the user identifier of the user permitted to download the data, the user identifier being assigned to each user; and
means responsive to a search request for the data, for checking whether the distributor identifier corresponding to the user identifier contained in the search request message exists in the distributor identifier list and making, when it is confirmed that the distributor identifier does not exist in the distributor identifier list, a reply to the user who has requested the search, indicating that the search is not allowed.

20. An index holding node for holding data location information, the index holding node being connected to at least one data distribution node holding data and at least one data download node via a data distribution network that exchanges data between the data download nodes or between the data download nodes and the data distribution nodes;
wherein the index holding node comprises:
means for holding an attribute of the data to be distributed which is notified from the data distribution node and which includes a unique distributor identifier assigned to the data distribution node in advance;
means for searching the location of the data by using the distributor identifier and a name of the data requested from the data download node and notifying the searched data location to the data download node;
means for holding a distributor identifier list in which the distributor identifier is associated with the user identifier of the user permitted to download the data, the user identifier being assigned to each user; and
means responsive to a search request for the data, for checking whether the distributor identifier corresponding to the user identifier contained in the search request message exists in the distributor identifier list and making, when it is confirmed that the distributor identifier does not exist in the distributor identifier list, a reply to the user who requested the search, the reply indicating that the search is not allowed.
